(19) United States
(12) Patent Application Publication
(10) Pub. No.: US 2005/0105501 A1
(43) Pub. Date: May 19, 2005

(54) Method for accessing access point in wirelass LAN and station

(75) Inventor: Satoshi Oura, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 10/985,801

(22) Filed: Nov. 10, 2004

(30) Foreign Application Priority Data
Nov. 19, 2003 (JP) 2003-389435

(51) Int. Cl. H04L 12/66

(52) U.S. Cl. 370/338

(57) ABSTRACT

A method for accessing an access point (AP) in a wireless LAN and a station are provided, in which the station determines current country and more effectively and quickly performs access to an AP when accessing the AP in a worldwide roaming environment. The method manages a plurality of profiles by grouping them for each country, and attempts to access systematically and automatically access points, which are set in the multiple profiles included in the profile groups of each country based on the country information in a beacon received from an AP. The country information and the profile information may be stored in a memory, and the access to the AP is performed based on the stored information, when next accessing an access point.

This application claims the benefit of Japanese Patent Application No.: 2003-389435, filed on Nov. 19, 2003, which is incorporated herein by reference.

### TECHNICAL FIELD

The present application relates to a method and apparatus for accessing an access point (AP) of a wireless local area network (LAN) and a station, and more particularly to a method for accessing an AP of a wireless LAN that can access APs in more than one country worldwide from a station.

### BACKGROUND

APs for wireless LAN have been widely deployed in stores and in various public areas, and users can use various telecommunication services through these APs. In addition, since international telecommunication services are growing rapidly, it may be desirable that the stations support a worldwide roaming function for accessing the wireless LANs.

Devices that have the capability to access APs in a wireless LAN, for example, PCs and portable computing appliances such as PDAs, need to be equipped with a station access application program for accessing the AP of the wireless LAN. Conventionally, when a user accesses APs of worldwide wireless LANs using such a device, the device needs to install a country-specific station application program (e.g., Japanese, Chinese, USA, UK) according to the type of the operating system (OS) installed in the PCs. During the process of accessing APs, the device changes operating parameters such as carrier frequency and channel, according to the information in a beacon that is received from the AP in the wireless LAN. Therefore, this method has a disadvantage in that a longer time is required to connect to the AP.

Prior to changing the operating parameters such as carrier frequency and channel, a beacon is received from the AP by scanning all of the possible channels (for example, all channels in the 2.4 GHz and 5.0 GHz bands for WiFi) including the parameters, when a user accesses an AP, and data, including the country information, is received from the beacon. Subsequently, the scanning must be performed at the channels corresponding to the country. Conventional methods have a problem in that they take a significant amount of time to connect to a desired AP.

These problems may become more severe since wireless LANs are internationally used and the number of the channels used increases, especially at 5.0 GHz, as well as the authorized frequency bands and protocols (as examples, IEEE 802.11a,b,g and h).

A conventional method for accessing AP in wireless LAN is disclosed in Japanese Unexamined Patent Application Publication No. 2000-184439.

### SUMMARY

A method more efficiently and rapidly accessing the AP of a wireless LAN and the country information concerning a region where a user accesses the AP, and a station having a worldwide roaming capability, is described.

One aspect provides a method for accessing an access point (AP) in a wireless LAN, comprising extracting country information from a beacon received from the access point when accessing the access point, and communicating with the access point by connecting to the access point which is included in a profile corresponding to the extracted country information; storing, in a memory, the country information extracted by connecting to the access point and profile information including information about the access point which may be used in the communicating step, and accessing the access point based on the country information and the stored profile information, including the access point, which may stored in the memory, when next accessing an access point.

Another aspect provides a station, which has worldwide roaming function, for accessing an access point in wireless LAN, the station comprises means for extracting country information included in a beacon received from the access point when the station accesses the access point, means for communication with the access point by connecting to the access point which is included in a profile of the extracted country information, and means for storing, in a memory, the country information extracted by connecting to the access point or profile information including information about the access point which may be used in the communicating step. When next accessing an access point, the access to the access point is performed based on the country information and the profile information including the information about the access point, which may be stored in the memory.

### BRIEF DESCRIPTION OF THE DRAWINGS

FIG. 1 shows an example of an access environment between an AP and a PC device according to an embodiment;

FIG. 2 shows a profile group that is used in an embodiment;

FIG. 3 shows a flowchart that describes a method for accessing an AP in a wireless LAN according to an embodiment; and

FIG. 4 shows a flowchart that describes in detail a procedure of Step 307 in FIG. 3.

### DETAILED DESCRIPTION

Exemplary embodiments may be better understood with reference to the drawings, but these embodiments are not intended to be of a limiting nature. Like numbered elements in the same or different drawings perform equivalent functions.

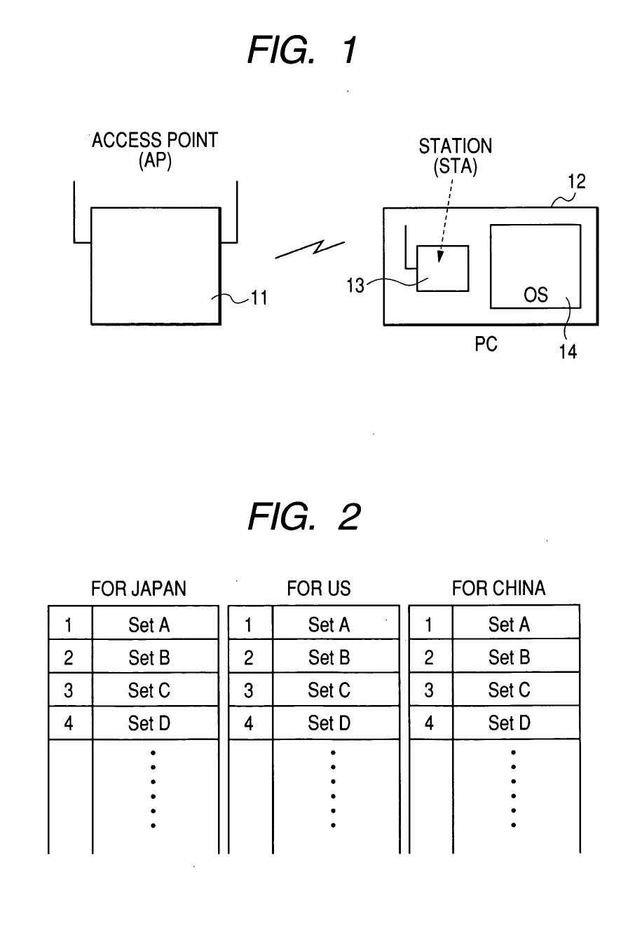

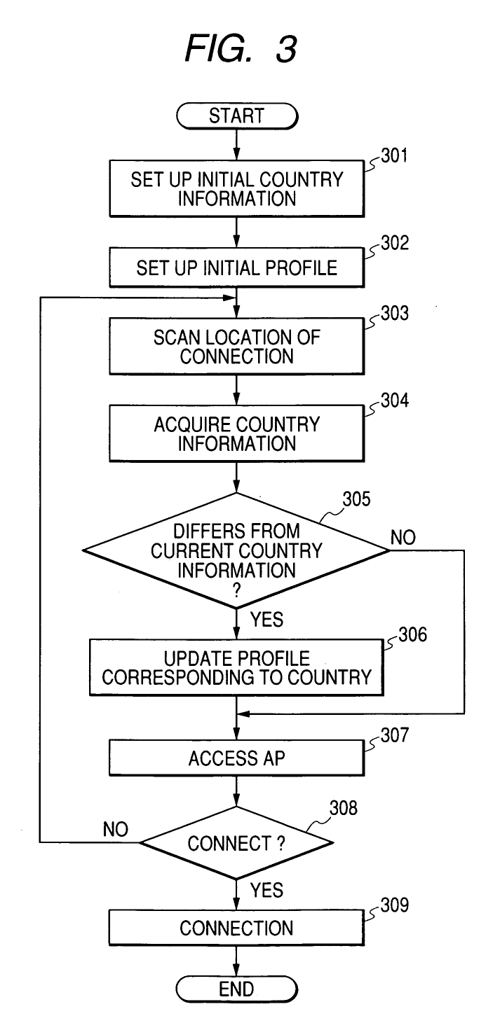

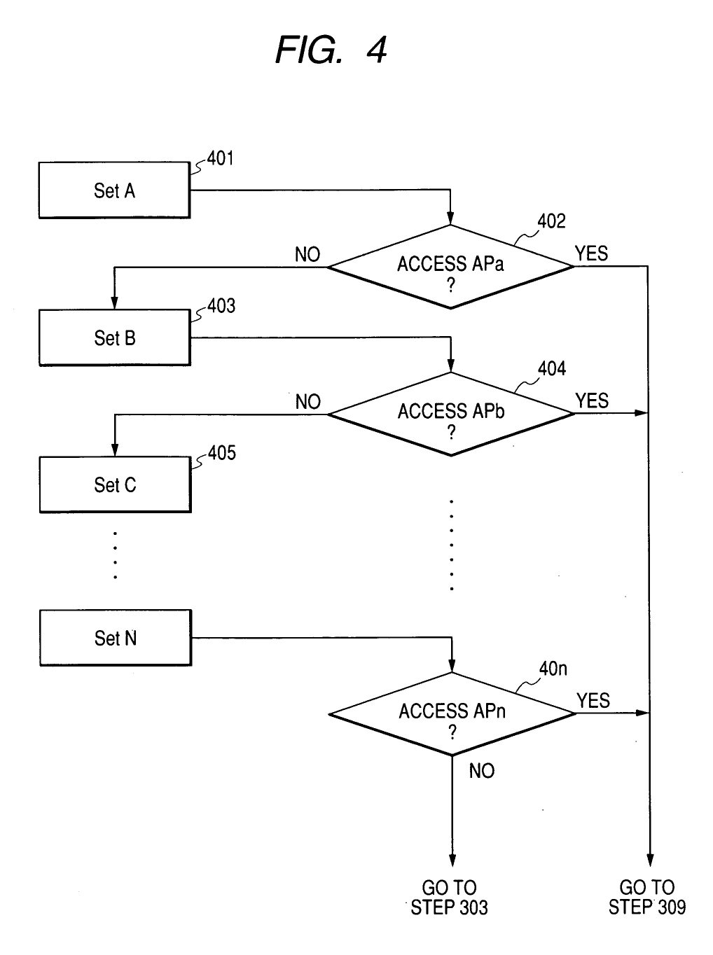

FIG. 1 shows an example of the access environment between the AP 11 the PC device 12, a communications station (STA) 13, and an OS, or other control or application program 14. FIG. 2 shows a group of country profiles which may be comprised of sets that are used in an embodiment. FIG. 3 shows the flowchart that illustrates a method for accessing the AP in the wireless LAN. FIG. 4 shows the flowchart that illustrates details of the procedure of the Steps 307 and 308 in FIG. 3.

The environment for accessing the AP is shown in FIG. 1. When a user desires to receive communication service by accessing AP 11 from a PC 12 which may comprise a STA 13 with a worldwide roaming function, the user accesses the AP 11 by bringing the PC 12 within an access region that is covered by the AP in the wireless LAN. The STA may be constructed and programmed to be compatible with a variety of physical layer protocols and communications protocols as may exist at the time, including one or more of IEEE Standards 802.11a,b,g, and h.

The PC 12 comprises a STA 13 with a worldwide (multi-country) roaming function and an OS 14. The STA 13 in which application programs are installed has functions that may discriminate the OS type and AP type of the wireless LAN. The PC may be a laptop computer, hand-held appliance (such as a PDA, cell phone) or the like, having at least non-volatile memory, a computational circuit, and adapted to interface with a STA. The STA may be integral to the PC or separate, such as a plug-in unit. The OS may be a stored program with characteristics appropriate for the countries where the device is intended to be operated, and may include all of the world for specific communications protocols. The OS may be stored in a memory of the PC. The term personal computer (PC) may be used to refer to the operative combination of the PC, the STA and the OS, whether incorporated in a single housing or separately, but acting together. (The term worldwide, is be used to signify that the device is constructed and/or programmed to operate in at least two countries.)

In order to roam worldwide, the STA 13 may first scan all channels (for example, in 2.4 GHz and 5.0 GHz bands), for the pre-programmed country specifications, to receive a beacon signal from the AP 11. It receives frames including the country information from the beacon and then changes the profile information based on the country information which may be contained in the beacon signal and the frames. The STA 13 may manage the profile group for each country. The beacon signal may include a Service Set Identifier (SSID), and the SSID may contain country information. The country profile table groups may be located in the PC and managed by the OS.

An example of profile groups that may be used, is shown in FIG. 2, and managed by profile group tables according to the country by grouping multiple profiles for each country as one group. FIG. 2 shows four profile tables for each of Japan, China, and US, however the STA 13 can have the capability manage more tables for each country and more countries. Each country group profile table may contain multiple profiles (Set A, Set B, Set C, Set D, etc) that contain information relating to the AP. The sets of profiles (e.g., Set A, Set B) may differ between countries. The information such as the address, mode, network name, channel number, and AP address for each profile may be stored in the profile information in advance. Information may be acquired from an AP once a communications connection has been established. This information may be used to update information stored in the profiles, and the information updated may not necessarily be limited to the present country of operation.

When the access to the AP 11 is first performed, the STA 13 in the PC 12 receives a beacon from the AP 11 which can be received at the location of the PC 12, extracts the country information from information included in the beacon, and selects the country group profile tables shown in FIG. 2 based on the extracted country information. Using the profile information which is stored and managed in the country group table, the STA 13 can subsequently access the AP 11.

Referring to flowchart shown in FIG. 3, a process for accessing the AP in the wireless LAN may be understood.

(1) A pre-determined country is selected initially, and a corresponding profile is initially set up (Step 301 and 302).

(2) The STA 13 scans one or more accessible connecting APs and searches for a valid network list, using the initially set profile information, and then acquires the country information included in the beacon that is received from the AP (Step 303 and 304).

(3) The STA 13 compares the country information in Step 301 with the country information acquired in Step 304, and determines whether or not they are same. If they are not the same, the profiles are updated to the country that is acquired from the information in the beacon. The country and profile update is performed by selecting a profile of the country group table corresponding to the country information, as shown in FIG. 2 (Step 305 and 306).

(4) If the access to the AP according to the profile in Step 306 fails, the STA 13 tries to sequentially access an AP from the multiple profiles in the corresponding country group profile table (Step 307). The process is described in detail referring to the flowchart shown in FIG. 4 (Step 307).

(5) By accessing the AP in Step 307, determination of whether or not the AP for the location of the connection (also referred to as the connecting place) is found. If the STA 13 finds a valid AP, the STA connects to the AP. However, if the STA 13 fails to find a valid AP, it tries to find another valid AP (an AP having same or different country information) by repeating the procedure from Step 303 (Step 308 and 309).

Next, the detailed procedure for Steps 307 and 308 for accessing the AP will be described with reference to the FIG. 4. The detailed procedures are designatd as Steps 401-40n.

(1) If the process starts, the STA tries to access the APa that is set as the first profile (Set A) in the profile table of the country corresponding to a country profile group table for the country which is initially set in the utility (Step 401). (APn represents any of the AP in the Set N of the selected country group.)

(2) As a result of the access to APa in Step 401, the STA in the user PC determines whether the access to APa is possible using a response from APa. If access is not possible, the STA tries to access APb that is set as the next profile (Set B) in the table of the corresponding country (Step 402 and 403).

(3) In the same way, as a result of the access to APb in Step 403, the STA determines whether the access to APb is possible or not using a response from APb. If access is not possible, the STA tries to access APc that is set as the next profile (Set C) in the table of the corresponding country. If access fails, the STA tries to access the AP after the next one so that the STA sequentially tries to access APs which are set to all profiles stored in the table of the corresponding country until the final profile (Set N) is reached. If access still fails, the STA moves to the procedure in Step 303 because a valid AP cannot be found (Step 404, 405 to 40n). Other country group settings and profiles can be searched, however the current country setting may not be changed until a new country setting has been determined, by a beacon or connection to an AP. This may minimize reconnection time where the station has not changed country location, but is temporarily unable to access an AP; this may occur, for example, by moving out of range of all APs or by a temporary service failure by the wireless LAN.

(4) In Step 402, 404, and 40n, the STA moves to the procedure in Step 309 if it can access an AP that is set up in the selected profile.

By connecting in Step 309, the PC 12 including STA 13 communicates with the AP 11, and receives various services. STA 13 stores the information of the profile, which is used in communicating with the AP 11, or the country information, into a non-volatile memory, hard disc, or the like, which is provided in the STA 13 or the PC 12.

When accessing to another AP, it is possible to more rapidly and easily access the AP by using the stored profile information or the country group information. When user moves the PC location in the same country, it is possible to more conveniently and quickly access the AP. When moving between countries, the method identifies the new country and updates the country information so that the next AP is accessed more conveniently and quickly.

The method can be performed using an application program or OS whose instructions may be stored in various media such as HD, DAT, FD, DVD-ROM, CD-ROM, and executed with a suitable computer or microprocessor.

As a result of the method for accessing AP in wireless LAN, by receiving the beacon from the AP 11 that can be received in the present location and extracting the country information from the information in the beacon, the method selects the country profile group table for the country based on the extracted country information to try to systematically access the AP 11 based on the profile information which is stored and managed in the table. Therefore, users can more conveniently and more quickly perform repeated access to the AP 11. Systematically connotes that there is one or more preprogrammed logical sequences in which the attempt to access the AP 11 is made. The selection of the preprogrammed logical sequence may be made based on a previous state of the device, operator input, or the like.

It will be evident to one skilled in the art that the method need not be performed in the order described in the embodiments, and the method may be commenced at various points in the sequence described, depending on the previous status of the communications station and the details of the OS or control program, or based on operator input.

Users can easily determine the AP information concerning the country where the user accesses APs during worldwide roaming as well as can more conveniently and more quickly perform connection to access points.

Further, the use of the word country does not limit the use of the method or apparatus to situation where country is synonymous with a political entity. Rather, any geographical area where a network is deployed, and where it may be useful to differentiate between networks, is intended. In addition, geographical areas associated with networks may overlap.

Although only a few exemplary embodiments of this invention have been described in detail above, those skilled in the art will readily appreciate that many modifications are possible in the exemplary embodiments without materially departing from the novel teachings and advantages of the invention. Accordingly, all such modifications are intended to be included within the scope of this invention as defined in the following claims.

1. An apparatus for accessing an access point in a wireless LAN, comprising:
means for extracting country information included in a beacon received from the access point;
means for communication with the access point by connecting to the access point which is included in a profile associated with the extracted country information; and
means for storing the country information extracted from the beacon and profile information including information about the access point which is used in the means for communicating with the access point; and
wherein, when communicating with the access point, the communicating is performed based on the country information and the profile information about the access point which have been stored by the means for storing.

2. The apparatus of claim 1, wherein the means for communication with the access point has a physical layer meeting the requirements of at least one of IEEE Standards 802.11a, 802.11b, 802.11g, and 802.11h.

3. The apparatus of claim 1, wherein the extracted beacon information includes a Service Set Identifier (SSID).

4. The apparatus of claim 1, wherein the means for communication is in communication with one of a PC and a hand held electronic appliance.

5. The apparatus of claim 1, where the one of a PC and a hand held electronic appliance has at least one of an OS or control program for performing the means for storing.

6. The apparatus of claim 4, wherein the country information is stored in at least one of HD, DAT, FD, DVD-ROM, CD-ROM, volatile memory or non-volatile memory.

7. The apparatus of claim 5, wherein at least one of the OS or control program comprises program instructions stored in volatile or non-volatile memory and executed by a microprocessor.

8. A method of accessing a wireless LAN, the method comprising:
selecting a profile from a country group table associated with country information stored in memory;
attempting to conduct communications with an access point contained in the selected profile;
selecting another profile from the country group table if communications is not established, providing that the another profile from the country group table is available;
repeating the attempting to conduct communications until either communications is established or all profiles in the country group table have been attempted;
selecting another country group table and repeating the attempting to perform communications until communications is established;
receiving a beacon from the access point and extracting country information from the beacon; and
comparing the country information extracted from the beacon with the country information stored in memory, and replacing the country information stored in memory with the country information extracted from the beacon, if the country information stored in memory and the country information extracted from the beacon are different;

9. The method of claim 8, wherein the receiving a beacon comprises attempting to receive the transmissions of the beacon on each channel frequency of a designated frequency band.

10. The method of claim 9, wherein the designated frequency band is at least one of a 2.5 GHz band and a 5 GHz band.

11. The method of claim 8, wherein the beacon is in accordance with at least one of IEEE Standards 802.11a, 802.11b, 802.11g and 802.11h.

12. The method of claim 8, wherein one or more country group tables are updated by communications conducted with the AP.

13. The method of claim 8, wherein the country information is contained in a Service Set Identifier (SSID).

14. A method of accessing a wireless LAN, the method comprising:
selecting a profile from a country group table of a plurality of country group tables associated with country information pre-stored in memory;
attempting systematically to conduct communications with an access point contained in the profile;
repeating the selecting a profile and the attempting systematically to conduct communications until either communications is established or all profiles in the country group table have been attempted;
repeating the selecting a country group table, selecting a profile and the attempting systematically to conduct communications, until either communications is established or all of the country group tables have been attempted;
replacing the pre-stored country information with the country information extracted from at least one of beacon transmissions and communications transmissions from the access point with which communications is established.

15. The method of claim 14, wherein one country group table contains each channel frequency of a designated frequency band.

16. The method of claim 15, wherein the designated frequency band is at least one of a 2.5 GHz band and a 5 GHz band.

17. The method of claim 14, wherein the beacon transmissions are in accordance with at least one of IEEE Standards 802.11a, 802.11b, 802.11g and 802.11h.

18. The method of claim 14, wherein at least one of the country group tables is updated by communications with the access point.

19. The method of claim 14, wherein the country information is contained in a Service Set Identifier (SSID).

20. A method for accessing an access point in a wireless LAN, comprising:
attempting to conduct communications with an access point using country information stored in memory;
conducting communications with the access point by connecting to the access point which is included in a profile;
extracting country information from a beacon transmission received from the access point;
storing, in a memory, the extracted country information and the profile which is used in the communicating with the access point; and
re-connecting to the access point based on the country information and the profile, which are stored in the memory.

21. A method of accessing an access point in a wireless LAN, the method comprising:
providing tables organized by country, the tables having profiles for each country provided therein;
pausing until communications is not being conducted with the access point;
receiving a beacon transmission from the access point and extracting country information from the beacon transmission;
selecting the table for the country associated with the extracted country information;
selecting one of the profiles contained in the table associated with the extracted country information;
attempting to conduct communications with the access point using the selected one of the profiles, and if communications is conducted, returning to the pausing until communications is not being conducted;
selecting another one of the profiles associated with the extracted country information;
repeating the attempting to communicate with the access point and the selecting another one of the profiles until all of the profiles associated with the extracted country information have been attempted; and
re-initiating the receiving the beacon transmissions.

22. The method of claim 21, wherein the country tables are updated by communications with the access point.
